(19) United States
(12) Patent Application Publication
(10) Pub. No.: US 2022/0188431 A1
(43) Pub. Date: Jun. 16, 2022

(54) API ACCESS TO SECURITY-SENSITIVE COMPUTING SYSTEM

(71) Applicant: International Business Machines Corporation, Armonk, NY (US)

(72) Inventors: Pradeep Parameshwaran, Boeblingen (DE); Nourhane Bziouech, Boeblingen (DE); Wilhelm Mild, Boeblingen (DE)

(21) Appl. No.: 17/120,330

(22) Filed: Dec. 14, 2020

(51) Int. Cl. G06F 21/62; G06F 9/54; G06F 11/30

(52) U.S. Cl. CPC G06F 21/6209; G06F 2221/2141; G06F 11/3072; G06F 9/547

(57) ABSTRACT

Controlling an (API) access action in a security-sensitive computing system includes, for an action to be performed, selecting from an operator account database an available operator account, generating a unique action tag which encompasses an identifier for the API access action and a unique API access key for executing the API access action; maintaining a dynamic access list having a mapping of the identifier of the API access action and the unique API access key and a selected operator account; granting, via the dynamic access list and the unique action tag, to the selected operator account an authorization for the API access to the security-sensitive computing system limited to performing the mapped API access; and revoking a further API access based on the unique action tag after the operator has performed the API access.

### BACKGROUND

The present invention relates generally to the field of a secured access action to a computing system, and more specifically, to a method for controlling an application programming interface (API) access action in a security-sensitive computing system.

### SUMMARY

According to one aspect of the present invention, a method for controlling an application programming interface (API) access action in a security-sensitive computing system is provided. Operations of the method may comprise for an action to be performed, selecting from an operator account database an available operator account, generating a unique action tag which encompasses an identifier for the API access action and a unique API access key for executing the API access action, and maintaining a dynamic access list, which has a mapping of the identifier of the API access action and the unique API access key and a selected operator account. Furthermore, the method may comprise granting, via the dynamic access list and the unique action tag, to the selected operator account an authorization for the API access action to the security-sensitive computing system limited to performing the mapped API access action, and revoking a further API access action based on the unique action tag, after the operator has performed the API access action.

According to another aspect of the present invention, an access control system for controlling an application programming interface (API) access action in a security-sensitive computing system is provided. The access control system may comprise a memory communicatively coupled to a processor, wherein the memory stores program code portions to enable the processor, for an API access action to be performed, to select from an operator account database an available operator account, to generate a unique action tag which encompasses an identifier for the API access action and a unique API access key for executing the API access action. The stored program code may enable the processor additionally to maintain a dynamic access list which has a mapping of the identifier of the API access action and the unique API access key and a selected operator account, to grant, via the dynamic access list and the unique action tag, to the selected operator account an authorization for the API access action to the security-sensitive computing system limited to performing the mapped API access action, and to revoke a further API access action based on the unique action tag, after the operator has performed the API access action.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that contains means for storing, communicating, propagating, and/or transporting the program for use, by, or in connection with, the instruction execution system, apparatus, or device.

### BRIEF DESCRIPTION OF THE DRAWINGS

FIG. 1 shows a block diagram of an embodiment of the inventive method for controlling an API access action in a security-sensitive computing system;

FIG. 2 shows a block diagram of components and relevant information flows of an embodiment of the present invention;

FIG. 3 shows a block diagram of a first part of components involved in the information flow of an embodiment of the present invention;

FIG. 4 shows a block diagram of a second part of components involved in the information flow of an embodiment of the present invention;

FIG. 5 shows an embodiment of the access control system for controlling an API access action in a security-sensitive computing system; and

FIG. 6 shows a computing system together with the access control system according to one aspect of the present invention.

### DETAILED DESCRIPTION

In the context of this description, the following conventions, terms and/or expressions may be used:

The term ‘application programming interface access action’—in short, API access action—may denote a call to an application programming interface of any kind. Examples may comprise APIs of operating systems, databases, configuration files, middleware components and/or application programs. The access to a component underlying the API may be performed by another program or directly by a user interface to the API. The access action may comprise any sort of influence to the component underlying the API including but not limited to a read access a write access, a change access and/or a delete access. Basically, every access action shall be understood as an access to a component underlying the API, wherein the access can change setting of the component.

The term ‘security-sensitive computing system’ may denote a highly secured computing system with a strict control of access to it. Often, such systems are implemented as a secure enclave in form of a portion of a complete so-called mainframe computing system, like an IBM Z system complex.

The term ‘operator account’ may denote a user ID (identifier) dedicated to an operator of the security-sensitive computing system. The access authorization for an operator user may go far beyond access rights of application users of the security-sensitive computing system. Up to now (i.e., in traditional systems) operator access rights may be a security threat to the security-sensitive computing system. The proposed concept may be instrumental to close that gap.

The term ‘unique action tag’ may denote a one-time-identifier and potentially also time-dependent—i.e., valid only for a predefined time period—for enabling a selected operator to perform a one-time API access action. Once the one-time API access action has been performed, the unique action tag may lose its validity. I.e., a second API access action of the same sort may be revoked.

The term ‘unique API access key’ may denote a digital code for enabling an access to a specific API.

The term ‘dynamic access list’ may denote a database or table mapping unique action tags and operators for a one-time API access action to a specific API.

The term ‘selected operator account’ may denote a user ID which has been selected to be authorized for the one-time API access action in order to perform an error correction or another required or recommended maintenance task.

The term ‘authorization for the API access action’ may denote that a selected operator may have a time-limited access right to the respective API.

The term ‘revoking a further API access action’ may denote that a revocation may happen after the unique API access key may have been used and that the potential problem may have been resolved or the maintenance task has been executed. There is no way to reuse the unique API access key in combination with the unique access tag a second time. This may increase the system security of the highly-secure computing system even more.

The term ‘secure appliance’ may denote a portion of our complete highly secured computing system, e.g., implemented as a secure enclave. Often, such systems are implemented in the form of a so-called mainframe computer system.

The term ‘secure enclave’ may denote a highly secured and often private computing environment as part of a larger computing complex. All accesses and accounts are typically secured by security key mechanisms.

The term ‘system log file’ may denote a list of activities that have occurred on a computer system. The list of activity may be time-tagged. Additionally, also users or sub-components involved may be listed as well, in combination with the performed activity.

The proposed method for controlling an application programming interface (API) access action in a security-sensitive computing system may offer multiple advantages, contributions and technical effects:

A core of the proposed concept may lie in the selective one-time actions and assignments to a selective group of system administrators who may perform a required action once, based on a dynamically generated access control list which may be determined based on a resolved action-tag. Once the authorization is given to a specific operator and the task at hand—i.e., access action to an API—has been finished, a second access to the API may be revoked.

Thus, the proposed concept may eventually be used to serve in IT environments with highly secured systems in which the operations teams shall have no direct—i.e., uncontrolled—access—i.e., in the form of ssh (secure shell) accesses—no direct access to operating system interfaces (only through pre-defined APIs), only highly controlled access to actions for a dedicated operator and wherein all API invocations should be audited and executed in a controlled and monitorable environment.

In a nutshell, the authorization given to the operation's team may be further restricted such that the highly secured computing environment may be even better self-controlled by its inherent self-monitoring subsystems.

The usage of a unique action tag for a given API access action which may become invalid after the given API access action has been performed may provide a sort of self-locking after the API access action has been performed. It may also be guaranteed that the intention of the API access action by the operator was successful.

If this was not the case, the access to APIs may also be automatically be extended—based on predefined rules and procedures (configurable)—in order to resolve a given system problem as quickly as possible.

In the following paragraphs, additional embodiments—applicable to the method as well as to the related system—will be described:

According to one embodiment of the method, the selected operator account may be a group of operator accounts. Thus, the selection of an appropriate operator for performing an access action to an API may be made based on an actual availability (e.g., “on duty”, not on vacation), based on skills or any other group definition characteristic. In a cloud computing environment, the selection of an operator or a group of operators may also be based on the client using a specific cloud computing system.

According to another embodiment of the method, the API access action may be a group of API access actions. This includes access action of different types to the same API and also API access actions to different APIs with the same or different access action(s). This may be advantageous for the following reason: If a malfunctioning system function may not be able to be repaired by a single API access action the authorization to perform additional API access actions may be triggered based on a predefined setting (or configuration) of the access control system. Thus, it is not required to restart the complete selection and assignment process of an API access action to an operator completely from the beginning. Hence, and according to another embodiment of the method the group of API access actions may refer to different APIs.

According to one embodiment of the method, the security sensitive system may be implemented as a secure appliance in form of a secure enclave. Such appliances or systems may be designed from ground up as highly protected systems preventing an open access to any components or its related APIs. Only highly secured and controlled users or other systems may be allowed or authorized to access such a secure appliance. However, typically operators may still be allowed to access the system APIs. In order to close this hole, the security system the proposed here may be instrumental.

According to another embodiment, the method also includes monitoring and analyzing a system log file—or a plurality thereof—for determining a requirement of an API access action. This may be performed by a logging and analysis system which may trigger a dynamic access control and action resolver ones a requirement for an access to an API of the secure appliance may have been determined.

According to an embodiment of the method, the API access action may be at least one selected out of the group comprising a modification to a configuration of the security-sensitive computing system—i.e., at least one resource or component of it—and an enablement of another component of the security-sensitive computing system. This may also comprise making available sleeping—i.e. inactive—components of the security-sensitive computing system, like, e.g., an additional processor core, more memory of more storage capacity or, higher memory bandwidth.

According to an embodiment of the method, the revoking the further API access action may also comprise monitoring a completion of the API access action before revoking the further API access action. Therefore, the authorized API access action may only be performed once. Based on the same access token now second API action may be possible once the specific access action has been completed. Hence, it is not possible—or better, it does not make sense—that an operator may store the access tag secretly for a later—in particular, unauthorized—usage. The later—i.e., second—usage would be revoked anyway.

According to an embodiment of the present invention, the method may also comprise extending an access controlled by the unique action key to an additional set of APIs if a previous access action did not arrive at a working solution. This may be especially useful if the problem to be solved or task to be performed cannot be completed with only one single API access action. Hence, a completion mark for a successful API access action should not be set. Consequently, and based on predefined rules and procedures an expansion of the APIs and potential actions required to solve the task at hand may be allowed automatically.

According to one embodiment of the present invention, the method may also comprise sending a notification to the selected operator account. Thereby, the notification may comprise a detail—in general more details—about a required API access action. The details may comprise additional background information, specific instructions, additionally required resources, actions to be performed upfront (worst-case shutdown of the computing system or a warning to active users) or backup activities.

In the following paragraphs, a detailed description of the figures will be given. All instructions in the figures are schematic. Firstly, a block diagram of an embodiment of the present invention for controlling an API access action in a security-sensitive computing system is given. Afterwards, further embodiments, as well as embodiments of the access control system for controlling an API access action in a security-sensitive computing system, will be described.

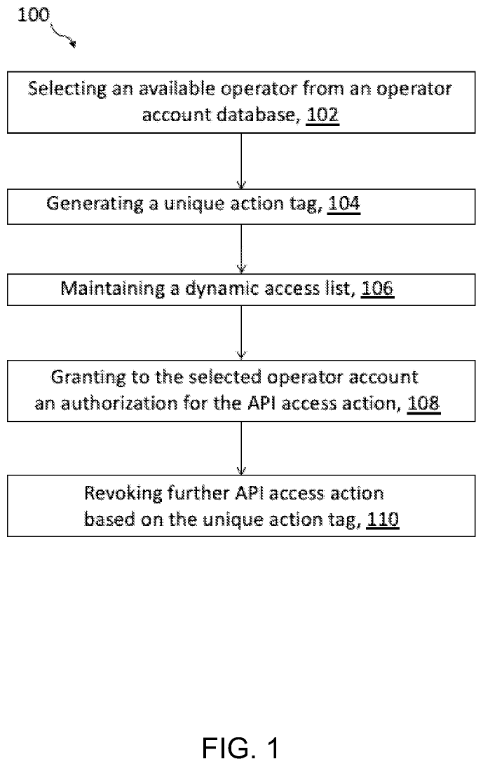

FIG. 1 shows a block diagram of an embodiment of the method 100 for controlling an application programming interface (API) access action in a security-sensitive computing system. The method 100 comprises for an action to be performed selecting, 102, from an operator account database an available operator account, generating, 104, a unique action tag which encompasses an identifier for the API access action and a unique API access key for executing the API access action.

The method 100 comprises additionally maintaining, 106, a dynamic access list, which has a mapping of the identifier of the API access action and the unique API access key and a selected operator account. It may be noted that the unique API access key is different to the unique action tag.

Additionally, the method 100 also comprises granting, 108, via the dynamic access list and the unique action tag, to the selected operator account an authorization for the API access action to the security-sensitive computing system limited to performing the mapped API access action only. Thereby, it may be noted that the mapping may be known from the dynamic access control list.

Finally, the method 100 comprises revoking, 110, a further API access action based on the unique action tag the operator has performed. Hence, the selected operator may perform the assigned task—i.e., the dedicated API access action identified by the unique action tag—only once.

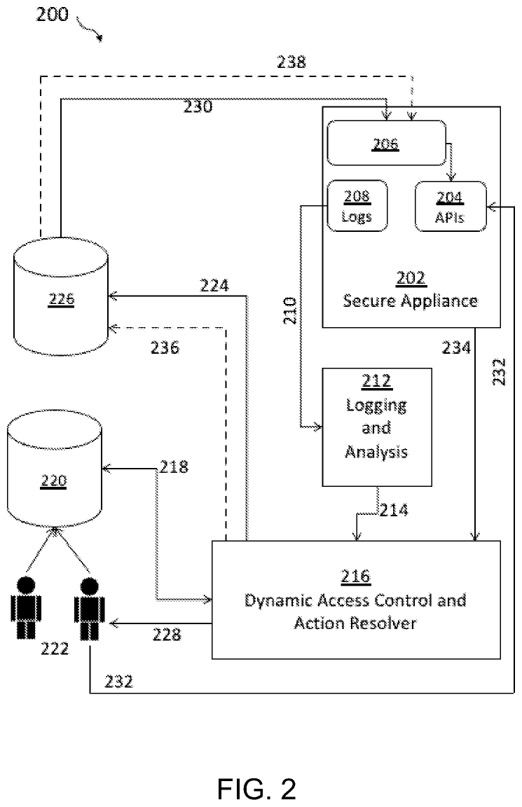

FIG. 2 shows a block diagram 200 of components and relevant information flows of an embodiment of the present invention. The flow starts from the log 208 which may be generated by the operation of the secure appliance 202, e.g., running on a mainframe (MF) computer system. The log file(s) 208 can be retrieved, 210, continuously and it/they also can be analyzed in a logging and analysis system 212. Upon an error or a maintenance requirement being determined, a notification is sent, 214, to the dynamic access control and action resolver 216.

The dynamic access control and action resolver 216 can access, 218, a list of available operators (220, list of operators on duty and/or skilled or generally authorized to perform the task at hand) and grant, 224, access to at least one of the selected operator(s) 222. At least one of the available operators 222 is registered as being on duty in the list 220 of operators on duty. The dynamic access control and action resolver 216 also notifies, 228, the selected operator to execute, 232, the permitted action (s) via the API(s) 204 to resolve the potential error or complete a required maintenance task. The access to the API is controlled by the APIs access management component 206 which receives, 230, a grant for an API access action for the selected operator 222.

Once the API access action is completed—which may be signaled, 234, by the API access management component 206, to the dynamic access control and action resolver 216—a further access to the API 204 is revoked, 236, 238, via the dynamic access list 226 (and the related controlling component) and the API access management component 206. It may be noted that the dynamic access control and action resolver 216 may actively check the secure appliance 202 or one of its components (e.g., the API access management component 206 or one of the log files 208) for the API access action completion.

It should be noted that the API(s) 204, the log files 208 and the API access management component 206 are all part of the secure appliance 202. Furthermore, the logging and analysis system 212 can—besides analyzing the log files for errors or required maintenance actions—decide or determine, based on the determined error or required maintenance action, that a specific API access action shall be performed.

Furthermore, the dynamic access control and action resolver 216 performs a list of instrumental activities supporting the hereby proposed concept: listen to the notifications from the logging and analysis system 212, extracting actions required per notification, determining a potential assignee (i.e., operator) on duty, create an action tag, register the action tag with the operator 222 to the dynamic access list 226, assigning the action tag and notifying the selected operator 222, resolving the action to be performed, verifying whether the API access action is initiated and/or completed and, invalidating the API action tag in the dynamic access list 226 so that a further API access is no longer possible (i.e., revoked).

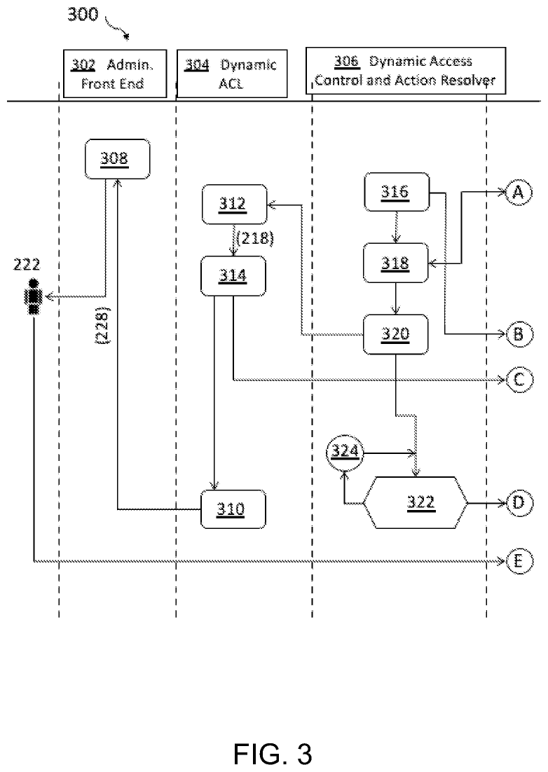

FIG. 3 shows a block diagram 300 of a first part of components involved in the information flow of an embodiment of the inventive concept. In the top portion of the figure involved components are listed: an administrator's front-end component 302, the dynamic access list 304 (compare dynamic access list 226 from FIG. 2) and the dynamic access control and action resolver 306 (compare the dynamic access control and action resolver 216 from FIG. 2).

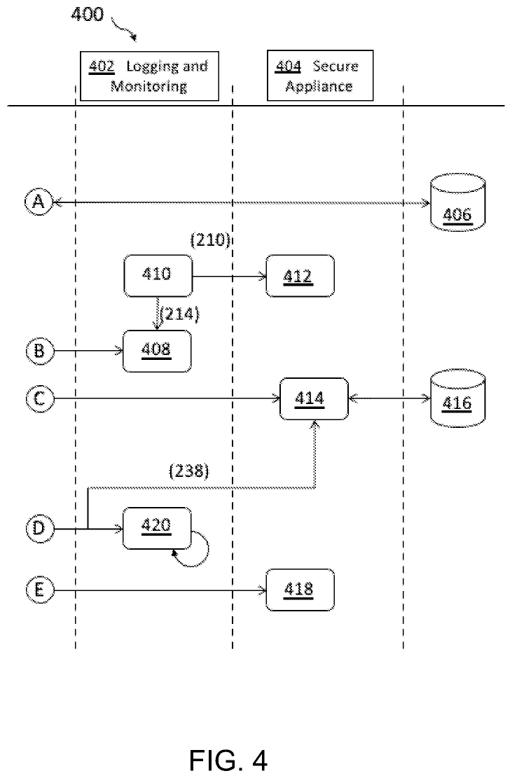

On the right side of FIG. 3 are flowchart connectors A, B, C, D, E shown which connect to respective continuation connectors on FIG. 4. For comprehensibility reasons, the total information flow had to be split between FIG. 3 and FIG. 4.

The actor, i.e., the selected operator 222 (compare FIG. 2) is shown on the left side of FIG. 3. The administrator's front-end 308 is permanently listening to notifications (228, FIG. 2) for a selected operator 222. A respective trigger signal is generated by the notifier 310. It may be related to the dynamic access control list 304. This may also apply for the activities of getting, 312, a notification from the dynamic access control and action resolver 306 so that a request, 314, for the access token for the assignee to the secure appliance is generated.

The dynamic access control and action resolver 306 comprises a notification listener component 316 which triggers an extraction, 318, of the access action(s) and determine the selected operator. Then a unique action tag for the operator is created, 320. Furthermore, the dynamic access control and action server 316 monitors, 322, and determines whether the API access action is performed in a predefined time. If this is not already the case, the process waits, 324, for a predefined period of time before the monitoring 322 is carried out again.

Referring now to FIG. 4, it can be seen that that there are some information bubbles indicating process flow connection exists between the dynamic access control and actually server 306 and the logging and monitoring component 402; these continuation connections are denotes as A, B, C, D, E. FIG. 4 shows a block diagram 400 of a second part of components involved in the information flow of the embodiment—jointly represented in FIG. 3 and FIG. 4—of embodiments of the present invention.

One can also see the connection—via A—from the triggering the extraction of the action (318 and the list 406 of operators on duty (equivalent to 220, FIG. 2). The notification listener process 316 is triggered—via B—after a determination, 408, which API access action(s) regarding potential error corrections of required maintenance tasks shall be performed. This is based on an analysis 410 of the log(s) 412 of the secure appliance 404. Here, it may also be mentioned that the reference numerals of FIG. 2 have been added to FIGS. 3 and 4 in brackets where appropriate.

One may also see—via C—the connection between the request, 314, the access token for the assignee—i.e., the selected operator—for the secure appliance and the API access management component 414 accessing information from the dynamic access list 416 (e.g., a database, compare 226, FIG. 2), as well as the logical connection between the operator 222 and the access to the API(s) 418 of the secure appliance 404. Furthermore—via D—a connection to a continuous health check 420 of the system is shown. Moreover, if the API access action is not carried out in the predefined period of time—via D—the API access management 414 is also informed that the potential API access action should be revoked.

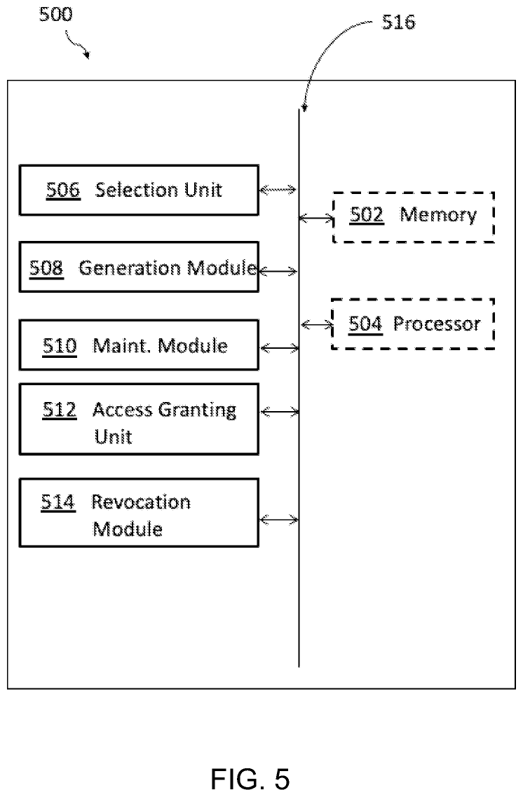

For completeness reasons, FIG. 5 shows an embodiment of the access control system 500 for controlling an API access action in a security-sensitive computing system. The system 500 comprises a memory 502 communicatively coupled to a processor 504, wherein the memory 502 stores program code portions (not shown) to enable the processor 504 for an API access action to select—in particular by a selection unit 506—from an operator account database an available operator account, generate—in particular by a generation module 508—a unique action tag which encompasses an identifier for the API access action and a unique API access key for executing the API access action, maintain—in particular by a maintenance module 510—a dynamic access list which has a mapping of the identifier of the API access action and the unique API access key and a selected operator account, grant—via an access granting unit 512—via the dynamic access list and the unique action tag, to the selected operator account an authorization for the API access action to the security-sensitive computing system limited to performing the mapped API access action, and revoke—in particular by a revocation module 514—a further API access action based on the unique action tag, after the operator has performed the API access action.

It may be noted that the activities of the access control system 500 may also be implemented completely as hardware components being in data exchange with the memory 502 and the processor 504. Consequently, the memory 502, the processor 504, the selection unit 506, the generation module 508, the maintenance module 510, the access granting unit 512 and their revocation module 514 may be connected among each other for data and information exchange. Alternatively, the active units and modules may be linked for data and signal exchange via the access control system internal bus system 516. This may make a complete hardware implementation elegantly implementable

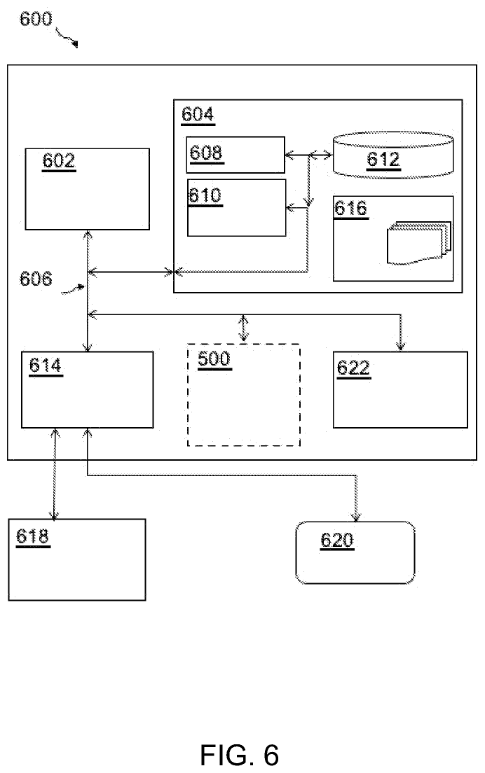

Embodiments of the invention may be implemented together with virtually any type of computer, regardless of the platform being suitable for storing and/or executing program code. FIG. 6 shows, as an example, a computing system 600 suitable for executing program code related to the proposed method.

The computing system 600 is only one example of a suitable computer system, and is not intended to suggest any limitation as to the scope of use or functionality of embodiments of the invention described herein, regardless, whether the computer system 600 is capable of being implemented and/or performing any of the functionality set forth hereinabove. In the computer system 600, there are components, which are operational with numerous other general purpose or special purpose computing system environments or configurations. Examples of well-known computing systems, environments, and/or configurations that may be suitable for use with computer system/server 600 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 600 may be described in the general context of computer system-executable instructions, such as program modules, being executed by a computer system 600. Generally, program modules may include routines, programs, objects, components, logic, data structures, and so on that perform particular tasks or implement particular abstract data types. Computer system/server 600 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 600 is shown in the form of a general-purpose computing device. The components of computer system/server 600 may include, but are not limited to, one or more processors or processing units 602, a system memory 604, and a bus 606 that couple various system components including system memory 604 to the processor 602. Bus 606 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 600 typically includes a variety of computer system readable media. Such media may be any available media that is accessible by computer system/server 600, and it includes both, volatile and non-volatile media, removable and non-removable media.

The system memory 604 may include computer system readable media in the form of volatile memory, such as random access memory (RAM) 608 and/or cache memory 610. Computer system/server 600 may further include other removable/non-removable, volatile/non-volatile computer system storage media. By way of example only, a storage system 612 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 606 by one or more data media interfaces. As will be further depicted and described below, memory 604 may include at least one program product having a set (e.g., at least one) of program modules that are configured to carry out the functions of embodiments of the invention.

The program/utility, having a set (at least one) of program modules 616, may be stored in memory 604 by way of example, and not limiting, as well as an operating system, one or more application programs, other program modules, and program data. Each of the operating systems, one or more application programs, other program modules, and program data or some combination thereof, may include an implementation of a networking environment. Program modules 616 generally carry out the functions and/or methodologies of embodiments of the invention, as described herein.

The computer system/server 600 may also communicate with one or more external devices 618 such as a keyboard, a pointing device, a display 620, etc.; one or more devices that enable a user to interact with computer system/server 600; and/or any devices (e.g., network card, modem, etc.) that enable computer system/server 600 to communicate with one or more other computing devices. Such communication can occur via Input/Output (I/O) interfaces 614. Still yet, computer system/server 600 may communicate with one or more networks such as a local area network (LAN), a general wide area network (WAN), and/or a public network (e.g., the Internet) via network adapter 622. As depicted, network adapter 622 may communicate with the other components of the computer system/server 600 via bus 606. It should be understood that, although not shown, other hardware and/or software components could be used in conjunction with computer system/server 600. Examples, include, but are not limited to: microcode, device drivers, redundant processing units, external disk drive arrays, RAID systems, tape drives, and data archival storage systems, etc.

Additionally, access control system 500 for controlling the API access action in the security-sensitive computing system may be attached to the bus system 606.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present invention has been presented for purposes of illustration and description, but is not intended to be exhaustive or limited to the invention in the form disclosed. Many modifications and variations will be apparent to those of ordinary skills in the art without departing from the scope and spirit of the invention. The embodiments are chosen and described in order to best explain the principles of the invention and the practical application, and to enable others of ordinary skills in the art to understand the invention for various embodiments with various modifications, as are suited to the particular use contemplated.

Some additional definitions are provided below:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Comprise/comprises/comprising: As used in the specification (specifically outside of the claims section), this term is intended to be perfectly synonymous with the term “include” and its various conjugated forms (as defined herein in this specification). The term “comprise” (and its various conjugated forms) as used in the claims is to be given its ordinary interpretation that is consistent with patent claim interpretation.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for controlling an application programming interface (API) access action, the method comprising:
selecting from an operator account database an available operator account,
generating a unique action tag which encompasses an identifier for the API access action and a unique API access key for executing the API access action,
maintaining a dynamic access list, which has a mapping of the identifier of the API access action and the unique API access key and a selected operator account,
granting, via the dynamic access list and the unique action tag, to the selected operator account an authorization for the API access action to a security-sensitive computing system limited to performing the mapped API access action, and
revoking a further API access action based on the unique action tag, after the operator has performed the API access action.

2. The method according to claim 1, wherein the selected operator account is a group of operator accounts.

3. The method according to claim 1, wherein the API access action is a group of API access actions.

4. The method according to claim 3, wherein the group of API access actions refers to different APIs.

5. The method according to claim 1, wherein the security sensitive system is implemented as a secure appliance in form of a secure enclave.

6. The method according to claim 1, further comprising:
monitoring and analyzing a system log file for determining a requirement of an API access action.

7. The method according to claim 6, wherein the API access action is at least selected out of the group comprising a modification to a configuration of the security-sensitive computing system and an enablement of a component of the security-sensitive computing system.

8. The method according to claim 1, wherein the revoking the further API access action further includes:
monitoring a completion of the API access action before revoking the further API access action.

9. The method according to claim 1, further comprising:
extending an access controlled by the unique action key to an additional set of APIs if a previous access action did not arrive at a working solution.

10. The method according to claim 1, further comprising:
sending a notification to the selected operator account, wherein the notification comprises a detail about the API access action.

11. An access control system for controlling an application programming interface (API) access action, the system comprising:
a processor(s) set;
a machine readable storage device; and
computer code stored on the machine readable storage device, with the computer code including instructions and data for causing the processor(s) set to perform operations including the following:
select from an operator account database an available operator account,
generate a unique action tag which encompasses an identifier for the API access action and a unique API access key for executing the API access action,
maintain a dynamic access list which has a mapping of the identifier of the API access action and the unique API access key and a selected operator account,
grant, via the dynamic access list and the unique action tag, to the selected operator account an authorization for the API access action to the security-sensitive computing system limited to performing the mapped API access action, and
revoke a further API access action based on the unique action tag, after the operator has performed the API access action.

12. The system according to claim 11, wherein the selected operator account is a group of operator accounts.

13. The system according to claim 11, wherein the API access action is a group of API access actions.

14. The system according to claim 13, wherein the group of API access actions refers to different APIs.

15. The system according to claim 11, wherein the security sensitive system is implemented as a secure appliance in form of a secure enclave.

16. The system according to claim 1, further comprising:
monitoring and analyzing a system log file for determining a requirement of an API access action.

17. The system according to claim 16, wherein the API access action is at least selected out of the group comprising a modification to a configuration of the security-sensitive computing system and an enablement of a component of the security-sensitive computing system.

18. The system according to claim 1, wherein the revoking the further API access action further includes:
monitoring a completion of the API access action before revoking the further API access action.

19. The system according to claim 1, further comprising:
extending an access controlled by the unique action key to an additional set of APIs if a previous access action did not arrive at a working solution.

20. A computer program product for controlling an application programming interface (API) access action, the computer program product comprising:
a machine readable storage device; and
computer code stored on the machine readable storage device, with the computer code including instructions and data for causing a processor(s) set to perform operations including the following:
select, one or more computing systems or controllers, from an operator account database an available operator account,
generate, one or more computing systems or controllers, a unique action tag which encompasses an identifier for the API access action and a unique API access key for executing the API access action,
maintain, one or more computing systems or controllers, a dynamic access list which has a mapping of the identifier of the API access action and the unique API access key and a selected operator account,
grant, one or more computing systems or controllers, via the dynamic access list and the unique action tag, to the selected operator account an authorization for the API access action to the security-sensitive computing system limited to performing the mapped API access action, and
revoke, one or more computing systems or controllers, a further API access action based on the unique action tag, after the operator has performed the API access action.
